(19) United States
(12) Patent Application Publication
(10) Pub. No.: US 2016/0334248 A1
(43) Pub. Date: Nov. 17, 2016

(54) TECHNIQUE FOR ROBUST DETECTION OF PLUGGED IMPULSE LINES

(71) Applicant: Honeywell International Inc., Morris Plains, NJ (US)

(72) Inventor: Jian Zhang, Shanghai (CN)

(21) Appl. No.: 15/221,534

(22) Filed: Jul. 27, 2016

Related U.S. Application Data
(63) Continuation of application No. PCT/CN2014/072786, filed on Mar. 3, 2014.

(51) Int. Cl. G01F 1/34

(52) U.S. Cl. CPC G01F 1/34

(57) ABSTRACT

A method includes collecting a set of process variable (PV) measurements generated using a sensor. The sensor is fluidly coupled to one or more impulse lines. The method also includes determining a median fluctuation in the set of PV measurements and determining a ratio using the median fluctuation and a reference median fluctuation. The method further includes determining whether at least one of the one or more impulse lines is plugged using the ratio. Determining whether at least one impulse line is plugged could include determining whether the ratio is below a threshold and, if so, determining that multiple impulse lines are plugged. Determining whether at least one impulse line is plugged could also include determining whether the ratio is above a first threshold or between second and third thresholds and, if so, determining that a single impulse line is plugged.

### CROSS-REFERENCE TO RELATED APPLICATION AND PRIORITY CLAIM

This application claims priority as a continuation of International Patent Application No. PCT/CN2014/072786 filed on Mar. 3, 2014. This international patent application is hereby incorporated by reference in its entirety.

### TECHNICAL FIELD

This disclosure relates generally to measurement systems. More specifically, this disclosure relates to a technique for robust detection of plugged impulse lines.

### BACKGROUND

Pressure transmitters are used in a wide variety of applications, such as to measure pressure, fluid level, or flow rate in an industrial process. In some applications, such as high-temperature or low-temperature environments or corrosive processes, one or more long tubes or pipes with small diameters (commonly called “impulse lines”) transmit pressure signals from a process to a pressure transmitter for measurement.

Over time, an impulse line can become plugged, partially or completely blocking a pressure signal from reaching a pressure transmitter. Typical blockages can include solid depositions, wax depositions, hydrate formations, sand plugging, gelling, frozen process liquid plugs, and air or foam pockets. As a specific example, in paper mills, impulse lines in paper pulp sections often become blocked by solid depositions.

The plugging of an impulse line can lead to erroneous pressure measurements and undesired control actions based on the erroneous measurements. For example, a process controller could attempt to modify an industrial process based on the erroneous measurements. This can lead to various detrimental effects, such as poor control of the industrial process, a loss of production, a plant shutdown, or even a safety hazard.

### SUMMARY

This disclosure provides a technique for robust detection of plugged impulse lines.

In a first embodiment, a method includes collecting a set of process variable (PV) measurements generated using a sensor, where the sensor is fluidly coupled to one or more impulse lines. The method also includes determining a median fluctuation in the set of PV measurements and determining a ratio using the median fluctuation and a reference median fluctuation. The method further includes determining whether at least one of the one or more impulse lines is plugged using the ratio.

In a second embodiment, an apparatus includes at least one memory configured to store a set of PV measurements generated using a sensor. The apparatus also includes at least one processing device configured to determine a median fluctuation in the set of PV measurements, determine a ratio using the median fluctuation and a reference median fluctuation, and determine whether at least one impulse line fluidly coupled to the sensor is plugged using the ratio.

In a third embodiment, a non-transitory computer readable medium contains instructions that, when executed by at least one processing device, cause the at least one processing device to collect a set of PV measurements generated using a sensor. The medium also contains instructions that, when executed by the at least one processing device, cause the at least one processing device to determine a median fluctuation in the set of PV measurements and to determine a ratio using the median fluctuation and a reference median fluctuation. The medium further contains instructions that, when executed by the at least one processing device, cause the at least one processing device to determine whether at least one impulse line fluidly coupled to the sensor is plugged using the ratio.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 through 3 illustrate examples of process variable (PV) sensors that operate using impulse lines according to this disclosure;

FIG. 4 illustrates an example system using at least one PV sensor according to this disclosure;

FIG. 5 illustrates an example pressure sensor according to this disclosure;

FIGS. 6 through 10 illustrate an example method for robust detection of plugged impulse lines according to this disclosure; and

FIGS. 11 through 13 illustrate examples of using a plugged impulse line detector (PILD) factor to detect one or more plugged impulse lines according to this disclosure.

### DETAILED DESCRIPTION

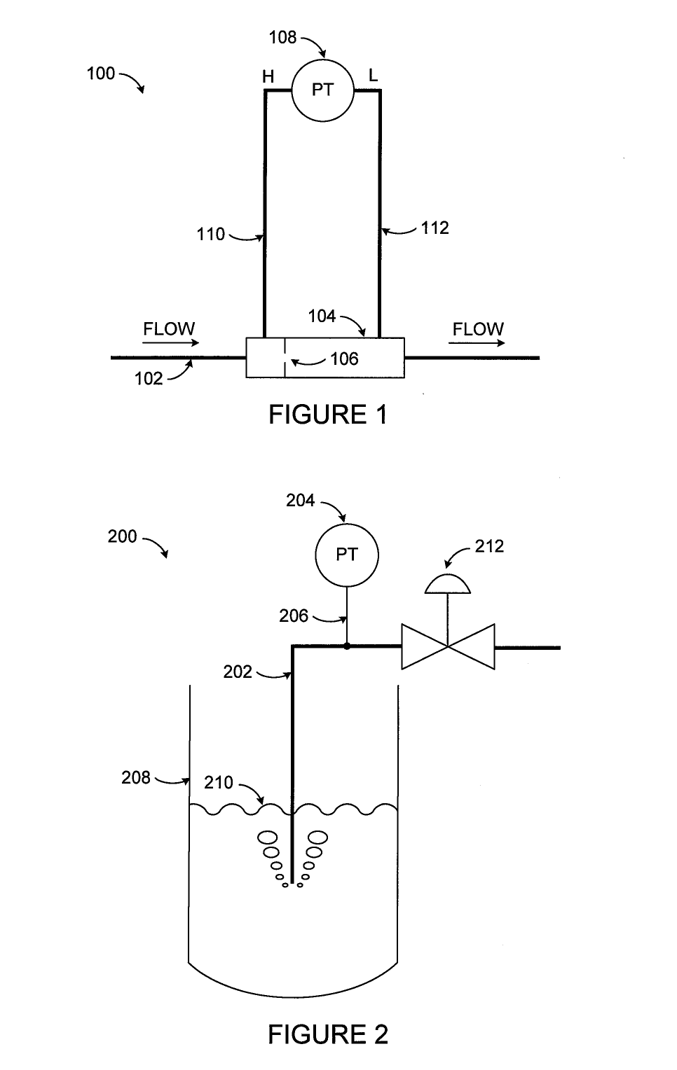

FIGS. 1 through 13, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIGS. 1 through 3 illustrate examples of process variable (PV) sensors that operate using impulse lines according to this disclosure. In particular, FIGS. 1 through 3 illustrate example systems in which pressure sensors that operate using impulse lines can be used. Other types of PV sensors could also be used.

As shown in FIG. 1, a system 100 is used to measure the flow of material through a conduit 102. The conduit 102 represents any suitable tube, pipe, or other structure through which fluid (such as liquid or gas) can flow. A portion 104 of the conduit 102 defines a space in which an orifice 106 is located. The orifice 106 denotes an opening that is smaller than the surrounding portion 104 of the conduit 102 in which the opening is located.

A pressure transmitter 108 is fluidly coupled to two impulse lines 110-112. The impulse lines 110-112 are fluidly coupled to the portion 104 of the conduit 102 on opposite sides of the orifice 106. The impulse lines 110-112 provide pressure signals from the conduit 102 to the pressure transmitter 108. In this example, the impulse line 110 is expected to transmit a higher pressure than the impulse line 112. For this reason, the impulse line 110 is referred to as a “high-side” impulse line, and the impulse line 112 is referred to as a “low-side” impulse line.

Pressures within different spaces of the conduit 102 are used by the pressure transmitter 108 to identify differential pressure (DP) measurements across the orifice 106. The differential pressure measurements identify the differences in pressures on opposite sides of the orifice 106. The differential pressures can be used in various ways, such as to identify the flow rate of material through the conduit 102.

Each of the impulse lines 110-112 includes any suitable tube, pipe, or other passage that allows a pressure signal to be provided to a pressure transmitter. Each of the impulse lines 110-112 could be formed from any suitable material(s) and in any suitable manner. Each of the impulse lines 110-112 could also have any suitable dimensions, such as a length of up to 1.8 meters or more.

If either of the impulse lines 110-112 becomes partially or completely plugged, the pressure transmitter 108 cannot accurately measure the differential pressure across the orifice 106. As a result, the flow rate of material through the conduit 102 may not be accurately measured and used. As explained in greater detail below, the pressure transmitter 108 (or an external component that operates using data from the pressure transmitter 108) can analyze pressure or other PV measurements to identify when one or both impulse lines 110-112 become partially or completely plugged.

As shown in FIG. 2, a system 200 is used to measure the pressure within a conduit 202, which in this example represents a passage for fluid. However, the conduit 202 could denote any other suitable structure in which a pressure is measured. A pressure transmitter 204 is fluidly coupled to an impulse line 206, which is fluidly coupled to the conduit 202. The pressure transmitter 204 is configured to measure the pressure within the conduit 202 via the impulse line 206. The pressure transmitter 204 could capture any suitable pressure measurements. In some embodiments, the pressure transmitter 204 captures absolute pressure (AP) or gauge pressure (GP) measurements. Absolute pressure measurements are based on a value of zero representing pressure in a vacuum (where only positive values are used). Gauge pressure measurements are based on a value of zero representing atmospheric pressure (where both positive and negative values are used). In other embodiments, the pressure transmitter 204 captures differential pressure measurements.

In this example, the conduit 202 is used to provide gas to a tank 208. The tank 208 represents any suitable structure that can hold at least one material 210. The tank 208 could be in a fixed position or portable, such as on a vessel. The material 210 could represent any suitable material(s), such as chemicals, petrochemicals, or water. The gas delivered via the conduit 202 can be used to create bubbles within the material 210, thereby implementing a “bubbler.” In this example, a valve 212 can be used to control the flow of gas through the conduit 202.

If the impulse line 206 becomes partially or completely plugged, the pressure transmitter 204 cannot accurately measure the pressure within the conduit 202. As a result, a blockage of the conduit 202 may go undetected, or other problems could occur. As explained in greater detail below, the pressure transmitter 204 (or an external component that operates using data from the pressure transmitter 204) can analyze pressure or other PV measurements to identify when the impulse line 206 becomes partially or completely plugged.

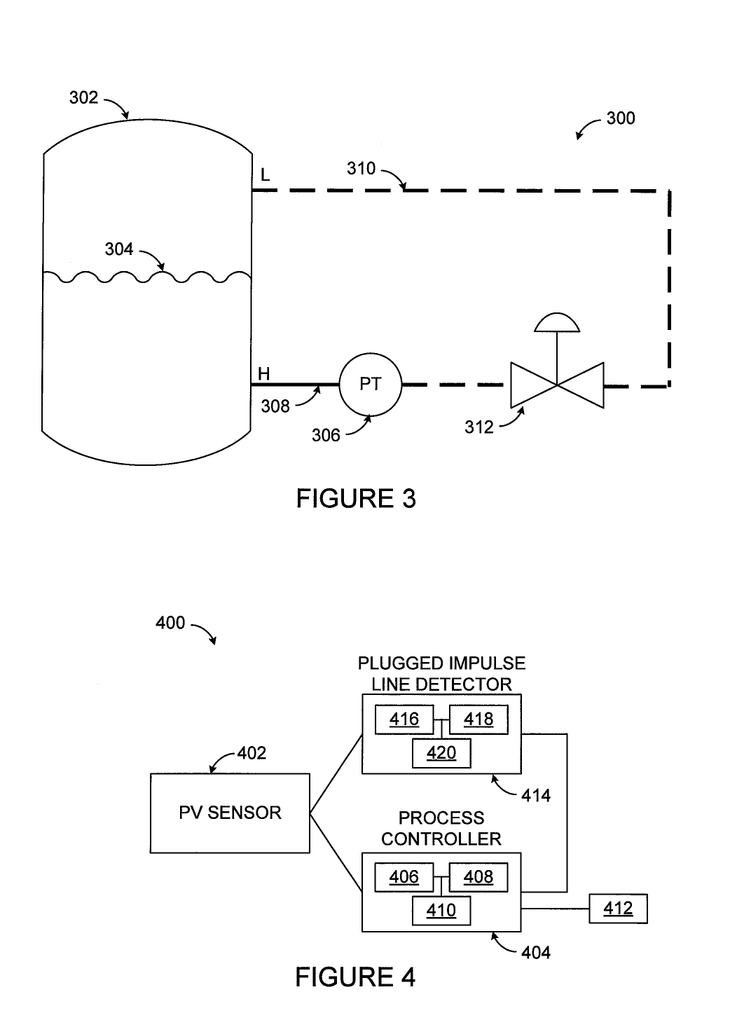

As shown in FIG. 3, a system 300 is used to measure the level of material in a tank 302. The tank 302 represents any suitable structure that can hold at least one material 304. The tank 302 could be in a fixed position or portable, such as on a vessel. The material 304 could represent any suitable material(s), such as chemicals, petrochemicals, or water.

A pressure transmitter 306 is fluidly coupled to a conduit 308, which could be connected at or near the bottom of the tank 302. The pressure transmitter 306 can also be fluidly coupled to an impulse line 310, which can fluidly connect to the tank 302 at or near the top of the tank 302. The pressure transmitter 306 can measure the absolute or gauge pressure within the conduit 308 or the differential pressure between the conduit 308 and the impulse line 310. By measuring pressure in this manner, it is possible to estimate the level of material 304 in the tank 302. For instance, the pressure within the impulse line 310 could represent a reference pressure within the tank 302, and the pressure within the conduit 308 could be based on the amount of material 304 in the tank 302 (along with the reference pressure). In this example, the impulse line 310 is fluidly connected to the pressure transmitter 306 via a valve 312, which could allow the pressure transmitter 306 to operate at desired times (such as only during times when material 304 is loaded or unloaded in the tank 302).

If the impulse line 310 becomes partially or completely plugged, the pressure transmitter 306 cannot accurately measure the level of material 304 in the tank 302. This could lead to material spills, undesirable control actions, or other problems. As explained in greater detail below, the pressure transmitter 306 (or an external component that operates using data from the pressure transmitter 306) can analyze pressure or other PV measurements to identify when the impulse line 310 become partially or completely plugged.

Although FIGS. 1 through 3 illustrate several examples of PV sensors that operate using impulse lines, various changes may be made to FIGS. 1 through 3. For example, FIGS. 1 through 3 are merely meant to illustrate different operational environments in which a process variable sensor can be used in conjunction with one or more impulse lines. The technique described below for analyzing PV measurements to identify when one or more impulse lines are plugged could be used with any suitable sensors and in any suitable system.

FIG. 4 illustrates an example system 400 using at least one PV sensor 402 according to this disclosure. The PV sensor 402 in FIG. 4 could represent the pressure transmitter 108 of FIG. 1, the pressure transmitter 204 of FIG. 2, or the pressure transmitter 306 of FIG. 3. Note, however, that any other suitable PV sensor(s) could be used.

The sensor 402 provides pressure or other process variable measurements to one or more external devices or systems, such as via one or more wired or wireless communication links. In this example, the sensor 402 can provide PV measurements to a process controller 404 and/or to a plugged impulse line detector (PILD) 414.

The process controller 404 can use the PV measurements to generate control signals for adjusting one or more characteristics of a process being controlled. The process controller 404 could be implemented using at least one processing device 406, at least one memory 408, and at least one interface 410. The process controller 404 could also present information (such as PV measurements) to an operator via one or more human machine interfaces (HMIs) 412, such as graphical displays. As described below, the process controller 404 could be configured to analyze the PV measurements from one or more PV sensors 402 and identify when one or more impulse lines fluidly connected to each sensor 402 is partially or completely plugged. If detected, the process controller 404 could take any suitable corrective action(s), such as generating an alarm (which could be presented on an HMI 412) or scheduling maintenance.

PV measurements could also or alternatively be provided to the PILD 414, either directly or indirectly (such as via the process controller 404). The PILD 414 can analyze the PV measurements from the sensor 402 and identify when one or more impulse lines fluidly connected to the sensor 402 are partially or completely plugged. If detected, the PILD 414 could take any suitable corrective action(s), such as generating an alarm or scheduling maintenance. The PILD 414 could be implemented using at least one processing device 416, at least one memory 418, and at least one interface 420. The PILD 414 could also analyze data from and identify problems with any number of sensors 402.

Although FIG. 4 illustrates one example of a system 400 using at least one PV sensor 402, various changes may be made to FIG. 4. For example, the functional division shown in FIG. 4 is for illustration only. Various components in FIG. 4 could be combined, further subdivided, or omitted and additional components could be added according to particular needs.

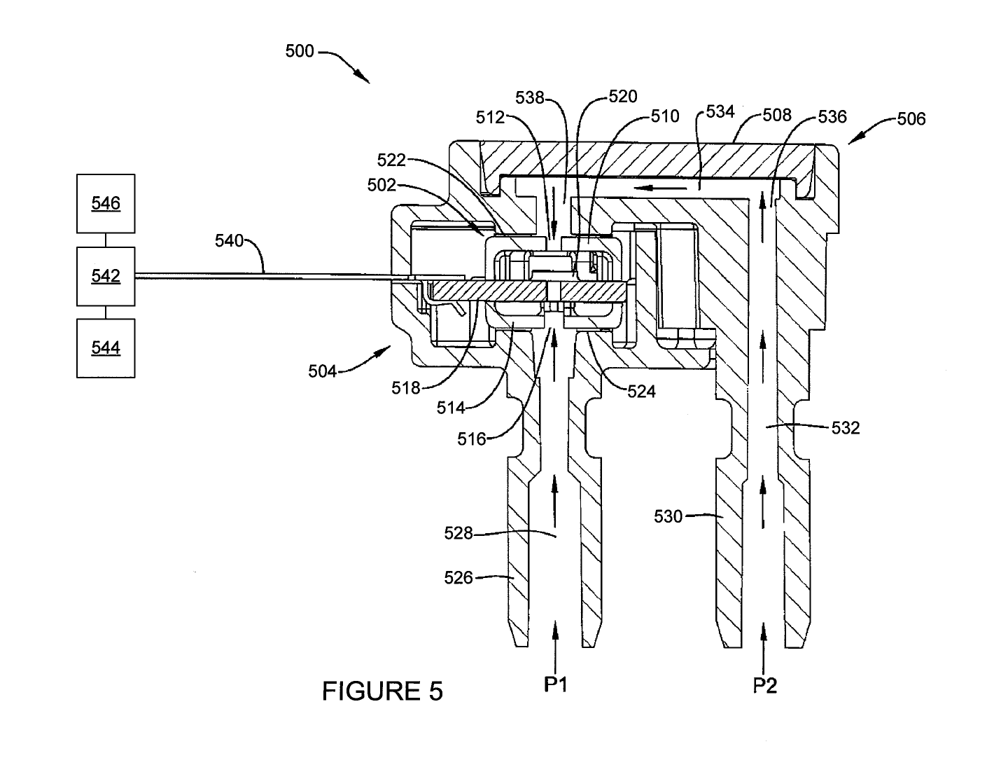

FIG. 5 illustrates an example pressure sensor 500 according to this disclosure. The pressure sensor 500 could, for example, be used as the pressure transmitter 108 of FIG. 1, the pressure transmitter 204 of FIG. 2, the pressure transmitter 306 of FIG. 3, or the PV sensor 402 of FIG. 4. The pressure sensor 500 could also be used in any other suitable system.

As shown in FIG. 5, the pressure sensor 500 includes a pressure sensor assembly 502 located within housing members 504-506. The pressure sensor assembly 502 measures a differential pressure, and the housing members 504-506 encase and protect the pressure sensor assembly 502. The housing members 504-506 represent any suitable structures configured to hold other components of the pressure sensor 500. In this example, a plug 508 can be attached to the housing member 506. The plug 508 includes any suitable structure that can be attached to a housing member.

The pressure sensor assembly 502 includes a top protective cover 510 having a pressure input port 512 and a bottom protective cover 514 having a pressure input port 516. The protective covers 510, 514 help to protect a substrate 518 that is positioned at least partially between the protective covers 510, 514. The pressure input ports 512, 516 allow multiple pressure signals to be delivered to a piezoresistive diaphragm 520 mounted on the substrate 518. The protective covers 510, 514 include any suitable structures for protecting at least part of a substrate. The pressure input ports 512, 516 could have any suitable size, shape, and dimensions.

The piezoresistive diaphragm 520 bends depending on the pressures on top and bottom of the diaphragm 520, which changes the resistance of the diaphragm 520. The substrate 518 can include circuitry that detects these changes in the resistance of the diaphragm 520, such as by applying a voltage across the diaphragm 520 and measuring the resulting current. Note that the use of a piezoresistive diaphragm 520 is for illustration only and that any other sensing element(s) could be used to detect pressure or differential pressure.

Adhesive rings 522-524 secure the protective covers 510, 514 to the housing members 504-506. Any suitable adhesive(s) could be used here. Note, however, that other techniques could be used to secure the protective covers 510, 514 to the housing members 504-506 or to other components of the sensor 500.

A first pressure P1 is provided to the pressure sensor assembly 502 via a pressure port 526 defining a first channel 528. A second pressure P2 is provided to the pressure sensor assembly 502 via a pressure port 530 defining a second channel 532 and via a third channel 534. The third channel 534 extends between an opening 536 into the second channel 532 and an opening 538 to the pressure sensor assembly 502. The third channel 534 could be at least partially defined by the plug 508, which could be adjusted to alter the third channel 534.

One or both of the pressure ports 526, 530 could be coupled to one or more impulse lines. In some embodiments, the first and second pressures P1 and P2 could both represent pressures received over impulse lines. In other embodiments, one of the pressures P1 and P2 could represent a pressure received over an impulse line, and another of the pressures P1 and P2 could represent another pressure (such as vacuum pressure or atmospheric pressure). In either case, the sensor 500 can operate to identify the differential pressure between P1 and P2 (although if one pressure is vacuum pressure or atmospheric pressure the resulting pressure measurement can be an AP or GP measurement, respectively).

One or more signal leads 540 can couple the substrate 518 to one or more external devices or systems. In this example, at least one signal lead 540 couples the substrate 518 to at least one processing device 542. The processing device(s) 542 can analyze signals from the substrate 518 to identify pressure measurements. The processing device(s) 542 could use any suitable technique to identify pressure measurements, such as an algorithm to convert resistances of the piezoresistive diaphragm 520 into pressure measurements. At least one memory 544 could be used to store instructions and data used, generated, or collected by the processing device(s) 542. At least one interface 546 facilitates communication with external devices or systems, such as the transmission of the pressure measurements.

As described in more detail below, the processing device 542 of the pressure sensor 500 could implement a technique to detect the presence of at least one plugged impulse line. As noted above, however, this functionality could also be performed outside of the pressure sensor 500.

Although FIG. 5 illustrates one example of a pressure sensor 500, various changes may be made to FIG. 5. For example, there are a wide variety of pressure sensors, and FIG. 5 does not limit the scope of this disclosure to any particular type of pressure sensor.

Each processing device 406, 416, 542 includes any suitable processing or computing device, such as a microprocessor, microcontroller, digital signal processor, field programmable gate array, application specific integrated circuit, or discrete logic devices. Each memory 408, 418, 544 includes any suitable storage and retrieval device, such as a random access memory (RAM) or a Flash or other read-only memory (ROM). Each interface 410, 420, 546 includes any suitable structure configured to communicate over a communication link, such as a Highway Addressable Remote Transducer (HART) interface, an Ethernet transceiver or radio frequency (RF) interface.

As can be seen in FIGS. 4 and 5, the ability to detect when one or more impulse lines fluidly connected to a PV sensor are partially or completely plugged can be implemented in a variety of ways. This functionality could be implemented within the PV sensor itself, by a process controller, or by a PILD (which could itself be incorporated into a PV sensor, process controller, or other device). This disclosure is intended to encompass all such possible implementations of this functionality. In particular embodiments, this functionality could be incorporated into the ADI 360 multipoint control unit (MCU) of a SMARTLINE ST800 smart pressure transmitter from HONEYWELL INTERNATIONAL INC. and configured via the HMI of the SMARTLINE ST800 transmitter.

As noted above, the plugging of an impulse line used by a PV sensor can create various problems, including safety issues in an industrial facility. One conventional approach to dealing with this problem involves performing maintenance on the impulse lines at periodic intervals. However, under this approach, impulse lines that are not plugged could be cleaned, and it is not possible to detect when problems arise between maintenance operations. Another conventional technique involves creating a “check pulse” that causes a process controller to adjust the industrial process and verifying that the PV sensor detects the change. While this approach may work for a static pressure system, check pulses could be ignored by a process controller in a dynamic pressure system.

In accordance with this disclosure, a technique is provided for the robust detection of plugged impulse lines. While this technique is described below as being performed by the PILD 414, the same or similar technique could be performed by a PV sensor, a process controller, or any other suitable device(s). Also, while described as being used in the system 400 of FIG. 4, this technique could be used in any suitable system with any suitable devices.

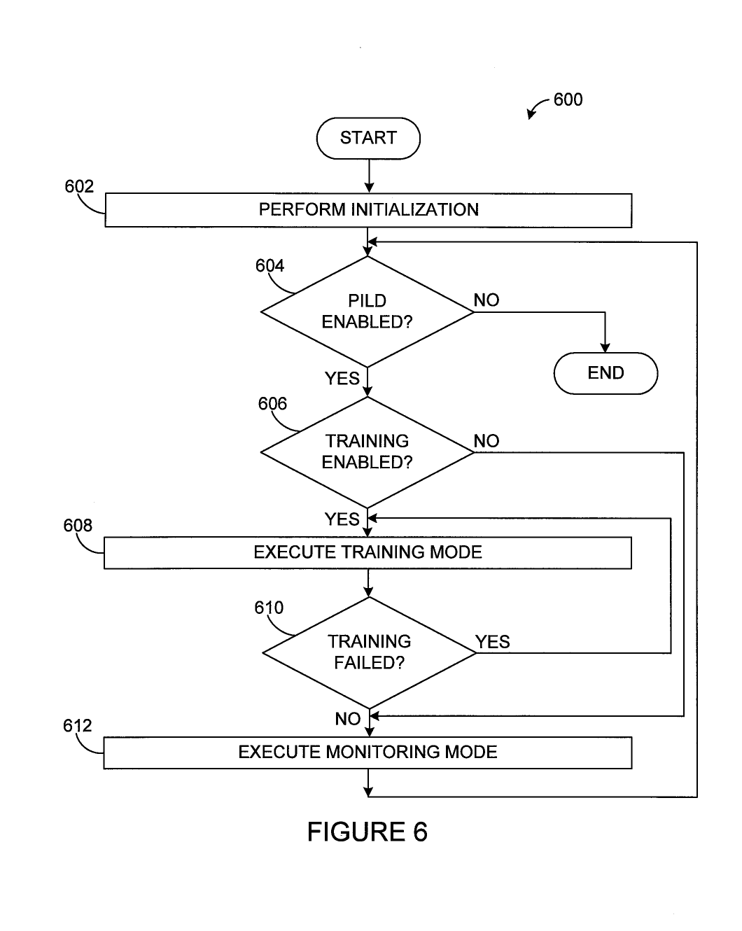

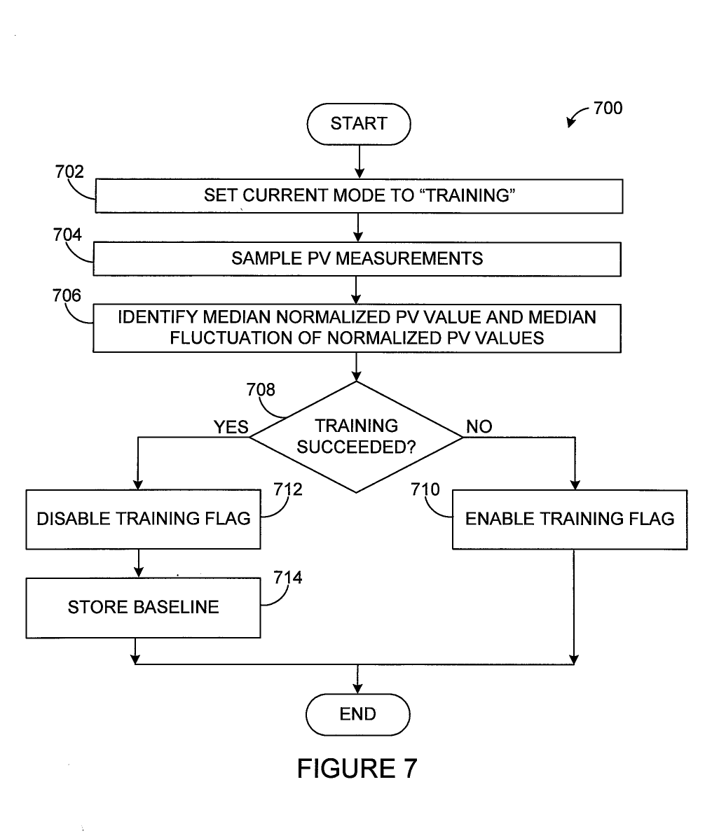

FIGS. 6 through 10 illustrate an example method for robust detection of plugged impulse lines according to this disclosure. More specifically, FIG. 6 illustrates an example method 600 for detecting plugged impulse lines, and FIGS. 7 through 10 illustrate example methods that could be used to implement various steps in the method 600 of FIG. 6.

As shown in FIG. 6, an initialization is performed at step 602. This could include, for example, the processing device 416 of the PILD 414 booting up and establishing communications with other devices, such as at least one PV sensor 402. A determination is made whether plugged impulse line detection is enabled for the PV sensor at step 604. If not, the method 600 can end.

If PILD is enabled, a determination is made whether a training mode is enabled for the PV sensor at step 606. The training mode can be used to identify one or more baseline reference values that are stored and later used to detect one or more plugged impulse lines. In some embodiments, the training mode can be used whenever the PILD 414 first begins operation or when a process being monitored undergoes a status change (such as a setpoint change). However, one or more baseline reference values could be computed or identified in other ways, such as when an operator provides the baseline reference value(s) to be used or when historical values are used to identify the baseline reference value(s). In these and other cases, the training mode may not be needed.

If the training mode is enabled, the training mode is executed at step 608. This could include, for example, the processing device 416 of the PILD 414 receiving process variable measurements from the PV sensor 402. Ideally, this can occur during a “normal” state of the PV sensor 402 in which there are no blockages of its impulse line(s) (as opposed to an “abnormal” state of the PV sensor 402 in which at least one impulse line is plugged). During the training mode, the PILD 414 can collect PV measurements from the sensor 402 and create a baseline for the sensor 402. The PV measurements could be obtained at any suitable frequency, such as at a 50 Hz sampling rate or lower. Also, any number of measurements could be obtained during the training mode. The PV measurements can be filtered (such as by a high-pass, low-pass, or band-pass filter) and normalized (such as by dividing each measurement by the upper range limit of the PV sensor 402). The PILD 414 can identify the median normalized PV value and the median fluctuation in the normalized PV values as the baseline.

A determination is made whether the training mode has failed at step 610. The training mode could fail if the training mode is interrupted or if the PV measurements collected during the training mode do not exhibit at least a threshold level of fluctuation. If so, the method 600 can return to step 608.

After the training mode, a monitoring mode is executed at step 612. During the monitoring mode, the processing device 416 of the PILD 414 could collect additional sensor measurements from the PV sensor 402 during one or more sampling windows. In each sampling window, the processing device 416 of the PILD 414 can identify a median normalized PV value and a median fluctuation of the normalized PV values. The median fluctuation of the normalized PV values for the current sampling window can be compared to the baseline value in order to identify a PILD factor, which is used as an indicator of whether plugging of one or more impulse lines is occurring. At some point (such as in response to a setpoint change or other status change to the process being monitored), the PILD 414 can exit the monitoring mode and return to the training mode for retraining.

As shown in FIG. 6, the training mode can be repeated, such as after a status change in the process. This is because a process often operates in a steady status or a transient status. The steady status occurs when one or more operating points, such as pressure or flow rate, are kept generally the same over time (such as when pumps, valves, or other devices are not turned on and off frequently). The transient status occurs when at least one operating point is changed significantly, such as in a very short period of time. Such changes can measurably impact the variable(s) monitored by a PV sensor 402, and in this case the PILD 414 should not identify the fluctuations in the PV measurements as a plugged impulse line. Because of this, the training mode can be repeated after a transient status, and the training mode could occur only during times when the process has a normal steady status. Note that a status change in the process being monitored could be detected in any suitable manner. For instance, a status change could be detected when the absolute value of the difference between the current normalized PV value and the baseline normalized PV value divided by the baseline normalized PV value exceeds a threshold. A status change could also be detected when the absolute value of the difference between the current PILD factor and 0.5 divided by 0.5 exceeds a threshold. In either case, exceeding the threshold can indicate that the underlying process being monitored has changed significantly since the training mode was last executed. However, automatic retraining of the PILD 414 could also be disabled if that functionality is not desired or if manual triggering of the training mode is needed or desired.

Note that median values (such as the median normalized PV value and the median fluctuation of the normalized PV values) are used above to help increase the robustness of the method 600. For the steady status of a process, the process' status can be described using various statistics of sampled PV measurements, such as the mean or standard deviation. However, PV measurements obtained during a transient status include abnormal data, which can greatly skew the mean or standard deviation. Using the median of a group of values provides a strong tolerance against abnormal data (for instance, if there are 50% abnormal data values, the median can still be robust).

FIG. 7 illustrates an example method 700 for performing a training mode. The method 700 could, for example, be executed as part of step 608 in FIG. 6. As shown in FIG. 7, the current mode of the PILD is set to “training” at step 702. PV measurements are sampled at step 704. This could include, for example, the processing device 416 of the PILD 414 identifying the PV measurements output by the PV sensor 402 during a specified sampling window. As noted above, any suitable sampling rate could be used, including a lower sampling rate (such as 50 Hz or less). Also, any number of sampled PV measurements can be collected. In some embodiments, the PILD 414 collects between 3,000 and 6,000 samples.

The median normalized PV value and the median fluctuation of the normalized PV measurements are identified at step 706. This could include, for example, the processing device 416 of the PILD 414 calculating normalized PV values (denoted PV_{NORM}[i]) and fluctuations in the normalized PV values (denoted F_{PV}[i]) as follows. In some embodiments, a normalized PV value PV_{NORM}[i] can be defined as:

$${PV}_{NORM} [ i ] = \frac{PV [ i ]}{URL} \qquad ( 1 )$$

where PV[i] denotes the i^{th} process variable measurement and URL denotes the upper range limit of the PV sensor 402. Fluctuations of the normalized PV values indicate (among other things) noise variations in the process variable. In some embodiments, the fluctuations F_{PV}[i] can be defined as:

F_{PV}[i]=|PV_{NORM}[i+1]−PV_{NORM}[i]| (2)

for 1=1, 2, . . . , n−1.

To help provide robust detection of plugged impulse lines, the baseline values identified during the training mode can represent the median normalized PV value and the median fluctuation of the normalized PV values. For an ordered set of values x_{[1]}≦x_{[2]}≦ . . . ≦x_{[n]}, the median can be defined as:

$$Median = \{ \begin{matrix}\frac{1}{2} ( {x}_{[ k ]} + {x}_{[ k + 1 ]} ) , & n = 2 k \\ {x}_{[ k + 1 ]} , & n = 2 k + 1\end{matrix} \qquad ( 3 )$$

This approach can be used to select the median normalized PV value from an ordered set of normalized PV values obtained using Equation (1) during the training mode. This approach can also be used to select the median fluctuation from an ordered set of fluctuations obtained using Equation (2) during the training mode.

A determination is made whether the training is successful at step 708. This could include, for example, the processing device 416 of the PILD 414 determining whether the median fluctuation in the normalized PV values exceeds some minimum threshold. If not, a training flag is enabled at step 710, where the training flag can be used to indicate that the training mode needs to be executed again. Otherwise, the training flag is disabled at step 712, and one or more baseline values are stored at step 714. This could include, for example, the processing device 416 of the PILD 414 storing the median normalized PV value and the median fluctuation in the normalized PV values as baseline values in the memory 418.

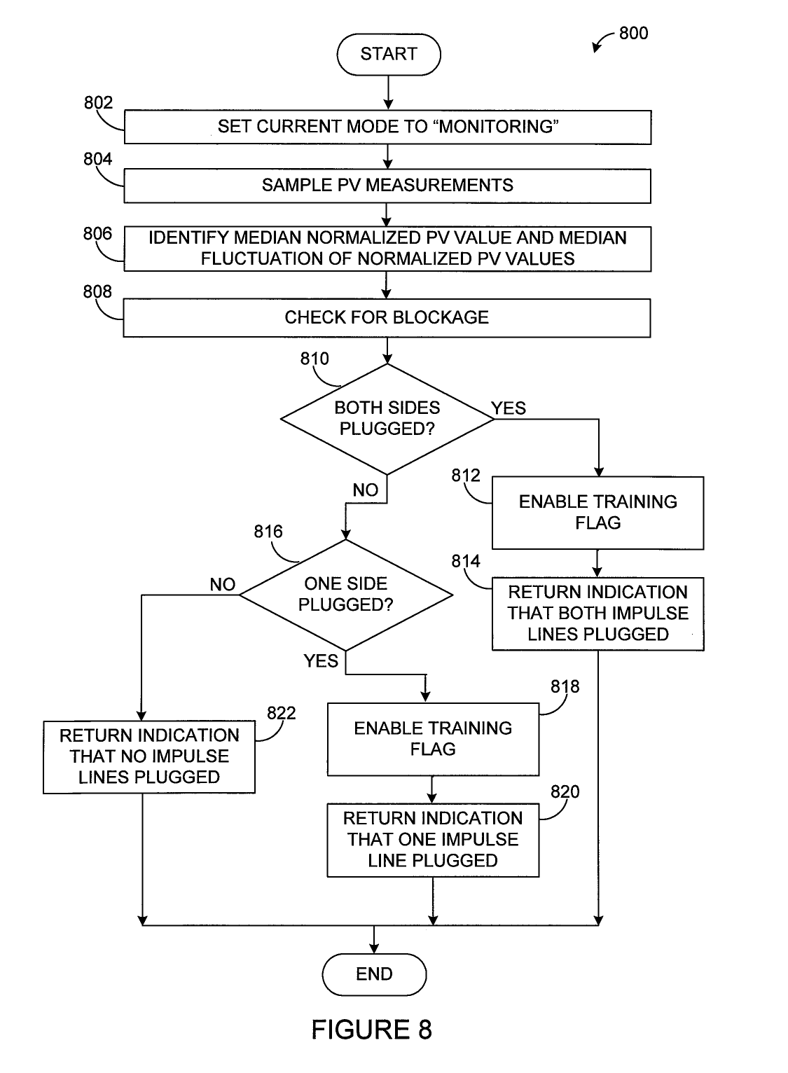

FIG. 8 illustrates an example method 800 for performing a monitoring mode. The method 800 could, for example, be executed as part of step 612 in FIG. 6. As shown in FIG. 8, the current mode of the PILD is set to “monitoring” at step 802. PV measurements are sampled at step 804. This could include, for example, the processing device 416 of the PILD 414 identifying the PV measurements output by the PV sensor 402 during a specified sampling window. As noted above, any suitable sampling rate could be used, and any number of sampled PV measurements can be collected.

The median normalized PV value and the median fluctuation of the normalized PV values are identified at step 806. This could include, for example, the processing device 416 of the PILD 414 using Equations (1)-(3) above to identify the median normalized PV value and the median fluctuation of the normalized PV values for the samples collected during the current sampling window.

A check is made whether one or more impulse lines associated with the PV sensor are blocked at step 808. As noted above, this could include the processing device 416 of the PILD 414 calculating a PILD factor and using the PILD factor as an indicator of whether plugging of one or more impulse lines is occurring. If both impulse lines associated with the PV sensor are identified as being plugged at step 810, the training flag is enabled at step 812, and an indication is returned that both impulse lines are plugged at step 814. The indicator can be used in any suitable manner, such as to trigger an alarm or schedule maintenance. Otherwise, if a single impulse line associated with the PV sensor is identified as being plugged at step 816, the training flag is enabled at step 818, and an indication is returned that one impulse line is plugged at step 820. Again, the indicator can be used in any suitable manner, such as to trigger an alarm or schedule maintenance. If not, an indication is returned that no impulse lines are plugged at step 822. At this point, the method 800 could be repeated for a subsequent sampling window, and this can continue until the monitoring mode ends.

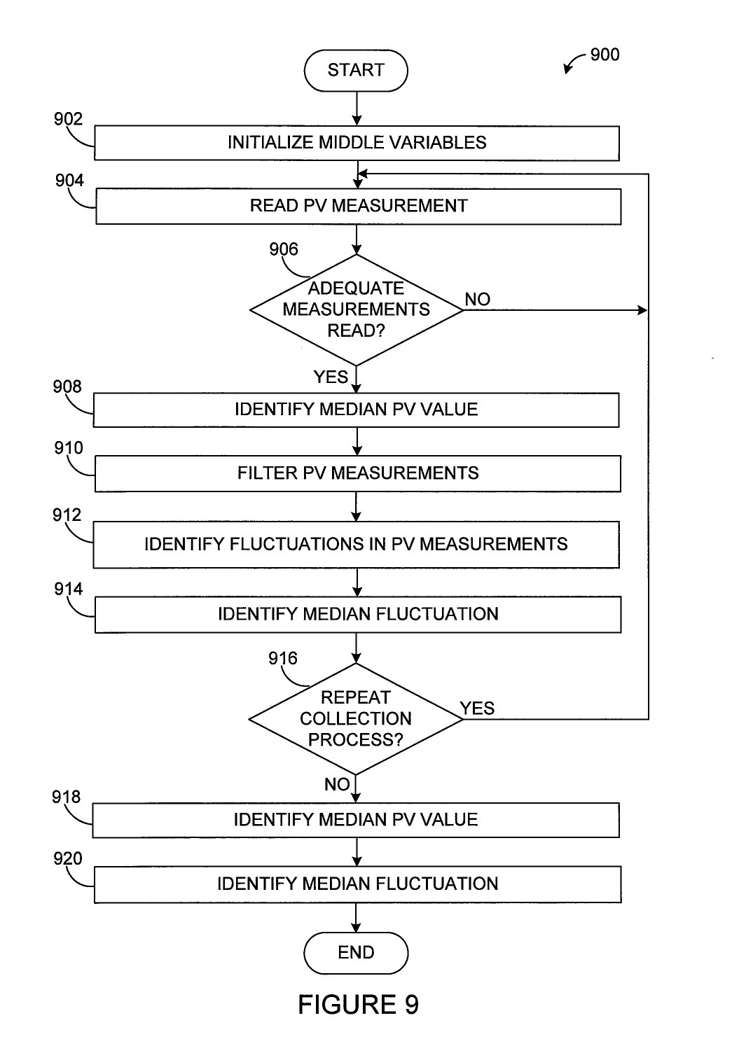

FIG. 9 illustrates an example method 900 for calculating the median PV value and the median fluctuation of the PV values. The method 900 could, for example, be executed as part of steps 704-706 in FIG. 7 or as part of steps 804-806 in FIG. 8. As shown in FIG. 9, middle variables are initialized at step 902. The middle variables represent the variables to be used to identify the median PV value and the median fluctuation of the PV values.

A PV measurement is read at step 904. This could include, for example, the processing device 416 of the PILD 414 identifying the current PV measurement output by the PV sensor 402. A determination is made whether enough measurements have been read at step 906. This could include, for example, the processing device 416 of the PILD 414 determining whether a specified number of PV measurements have been sampled by the PILD 414. If not, the process returns to step 904.

The median of the PV measurements is identified at step 908. The PV measurements are filtered at step 910 (such as with a high-pass, low-pass, or band-pass filter), fluctuations in the PV values are identified at step 912, and the median fluctuation is identified at step 914. These calculations could, for example, be performed using Equations (1)-(3) above.

A determination is made whether the collection process should be repeated at step 916. In some embodiments, multiple sets of PV measurements can be obtained and analyzed to identify multiple median PV values and multiple median fluctuations. If so, the process returns to step 904 to repeat steps 904-914. Otherwise, the median PV value is identified at step 918, and the median fluctuation is identified at step 920. The median PV value could represent the median PV value determined for all iterations through steps 904-916, and the median fluctuation could represent the median fluctuation determined for all iterations through steps 904-916. Note, however, that if only a single set of PV measurements is obtained, the median values found in steps 908 and 914 could be used. Also note that while not shown here, the PV values could be normalized (such as during step 904), and the median values identified could represent the median normalized PV value and the median fluctuation in the normalized PV values.

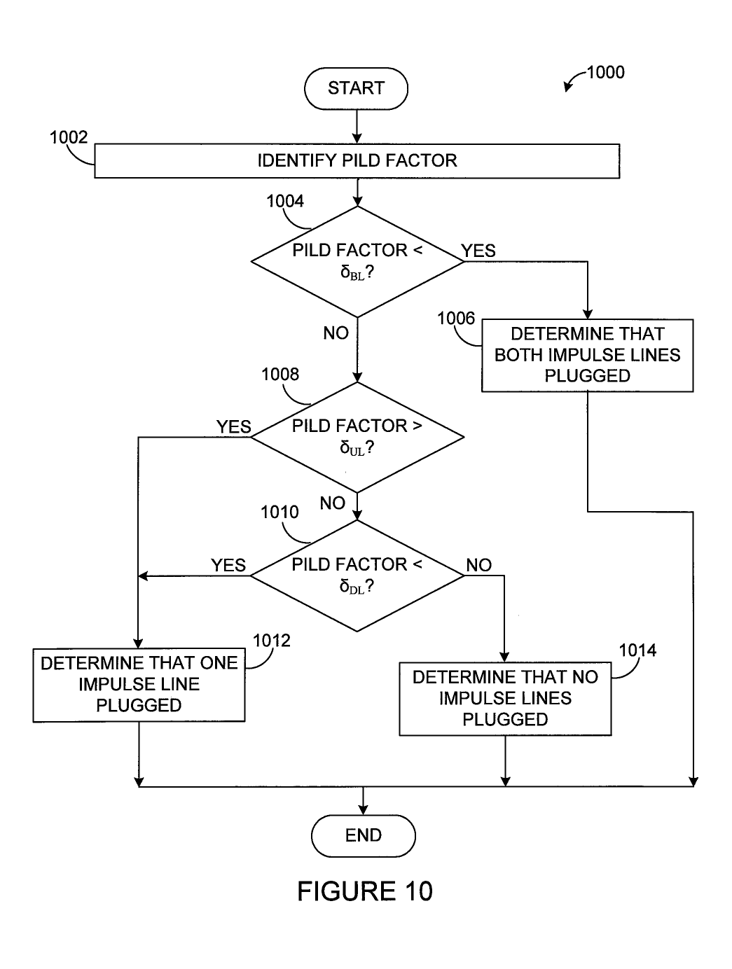

FIG. 10 illustrates an example method 1000 for determining if blockage in at least one impulse line is detected. The method 1000 could, for example, be executed as part of step 808 in FIG. 8. As shown in FIG. 8, a PILD factor for a current set of PV samples is identified at step 1002. This could include, for example, the processing device 416 of the PILD 414 calculating the PILD factor using the median fluctuation for the current set of PV samples and the reference median fluctuation identified during the training mode. In some embodiments, the PILD factor can be defined as:

$$PILD Factor = \frac{θ}{1 + θ} \qquad ( 4 )$$

Here, θ can be defined as:

$$θ = \frac{{\hat{F}}_{PV}}{1 + {\hat{F}}_{PV\_REF}} \qquad ( 5 )$$

where \hat{F}_{PV} represents the median fluctuation of the normalized PV values in the current sampling window (collected during the monitoring mode) and \hat{F}_{PV}_{_}_{REF} represents the baseline median fluctuation of the normalized PV values (identified during the training mode). According to Equation (4), the PILD factor could range between 0 and 1 inclusive (denoted as [0,1]).

A determination is made whether the PILD factor is less than a threshold δ_{BL} at step 1004. The δ_{BL} threshold can be set relatively close to zero and is indicative of both impulse lines being plugged. As a result, if the PILD factor is less than the δ_{BL} threshold, a determination is made that both impulse lines are plugged at step 1006.

Otherwise, a determination is made whether the PILD factor is greater than a threshold δ_{UL} at step 1008. The δ_{UL} threshold can be set greater than 0.5 and is indicative of a single impulse line being plugged. If not, a determination is made whether the PILD factor is less than a threshold δ_{DL} at step 1010. The δ_{DL} threshold can be set less than 0.5 and higher than the δ_{BL} threshold and is also indicative of a single impulse line being plugged. If the PILD factor is greater than the δ_{UL} threshold or between the δ_{BL} and δ_{DL} thresholds, a determination is made that a single impulse line is plugged at step 1012. Otherwise, a determination is made that no impulse lines are plugged at step 1014.

Table 1 below summarizes the use of the PILD factor in detecting one or more plugged impulse lines.

TABLE 1

| PILD Factor | Status | Description |
|---|---|---|
| Between δ_{DL} and | “Not Blocked” - No | δ_{DL ∈} [δ_{DL},0.5] is the down limit of |
| δ_{UL} | impulse lines plugged | the “Not Blocked” status. |
| | | δ_{UL ∈} [0.5,1] is the up limit of the |
| | | “Not Blocked” status. |
| Between 0 and δ_{BL} | “Both Blocked” - | δ_{BL} is the limit of the “Both |
| | Both impulse lines | “Blocked” status. |
| | plugged | |
| Between δ_{UL} and 1 | “One Blocked” - One | Indicates that one of the high-side |
| | impulse line plugged. | and low-side impulse lines is |
| | | plugged. |
| Between δ_{BL} and | “One Blocked” - One | Indicates that one of the high-side |
| δ_{DL} | impulse line plugged. | and low-side impulse lines is |
| | | plugged. |

Note that the δ_{UL}, δ_{BL}, and δ_{DL} thresholds can vary depending on the type of system being monitored. In some embodiments, these thresholds can be determined experimentally or estimated through modeling. In particular embodiments, the δ_{BL} threshold could have a value between 0.1 and 0.2 inclusive, the δ_{DL} threshold could have a value of 0.4, and the δ_{UL} threshold could have a value between 0.6 and 0.8 inclusive.

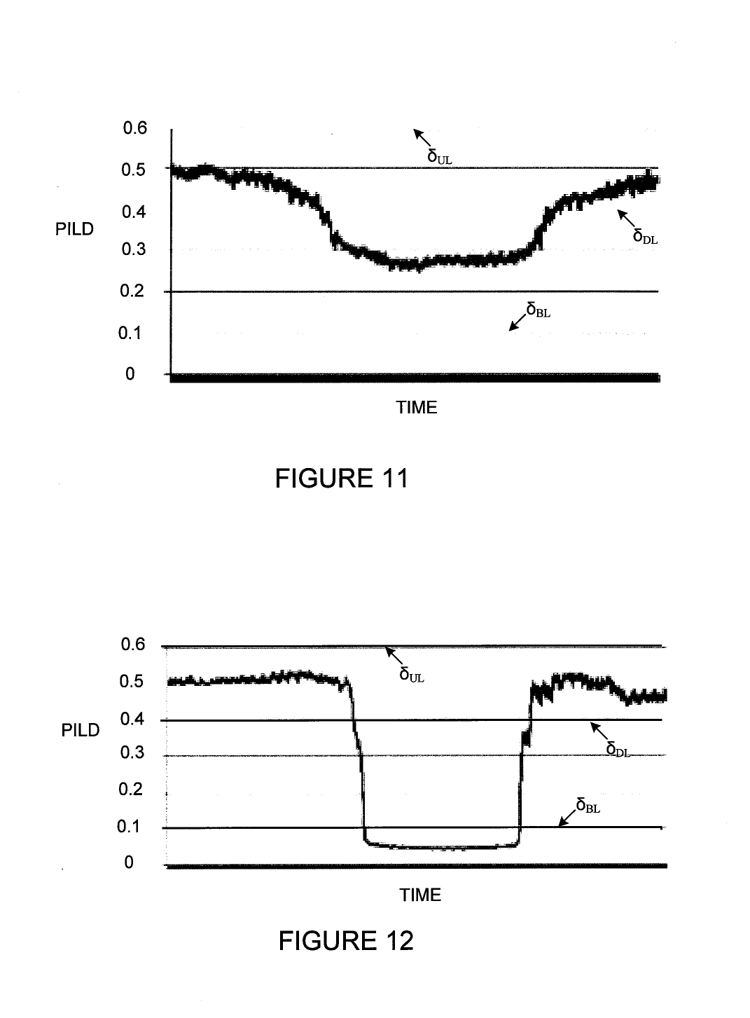

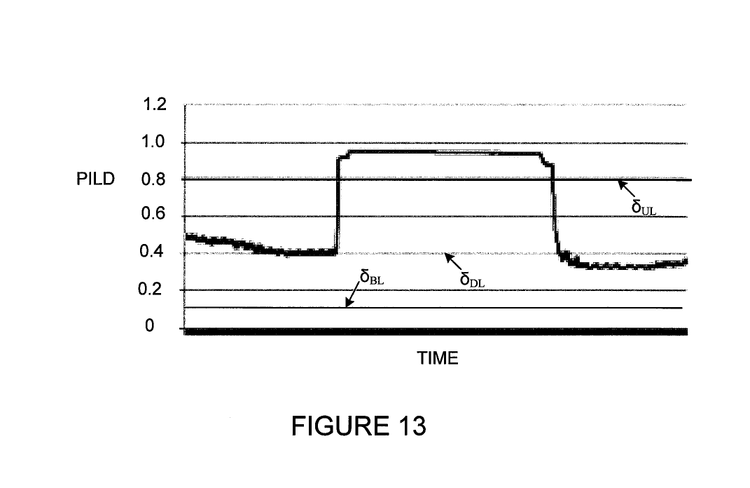

FIGS. 11 through 13 illustrate examples of using a PILD factor to detect one or more plugged impulse lines according to this disclosure. FIGS. 11 through 13 all plot PILD factor values (on the vertical axis) over time (on the horizontal axis). In FIG. 11, the PILD factor drops below the δ_{DL} threshold but remains above the δ_{BL} threshold, which is indicative that a single impulse line is plugged. In FIG. 12, the PILD factor drops below the δ_{BL} threshold (which is below the δ_{DL} threshold), which is indicative that both impulse lines are plugged. In FIG. 13, the PILD factor rises above the δ_{UL} threshold for a time and also falls below the δ_{DL} threshold for a time, which is indicative that a single impulse line is plugged.

Note that in the flowcharts described above, it is assumed that the PV sensor is a differential pressure sensor or other sensor having multiple impulse lines. However, these flowcharts could easily be modified for use with a PV sensor having a single impulse line by omitting various steps. For instance, steps 810-814 could be omitted in FIG. 8, and steps 1004-1006 could be omitted in FIG. 10.

Although FIGS. 6 through 10 illustrate one example of a method for robust detection of plugged impulse lines, various changes may be made to FIGS. 6 through 10. For example, various steps in each figure could be combined, moved, or omitted and additional steps could be added according to particular needs. Also, while each figure shows a series of steps, various steps in each figure could overlap, occur in parallel, or occur any number of times. In addition, note that FIGS. 7-9 all show samples of PV measurements being taken. The samples captured in FIGS. 7-9 could be the same samples captured in the same sampling window(s), different samples captured during different sampling windows, or a combination thereof. Although FIGS. 11 through 13 illustrate examples of using a PILD factor to detect one or more plugged impulse lines, various changes may be made to FIGS. 11 through 13. For instance, the PILD factor values shown here relate to specific instances of impulse line plugging, and other instances of impulse line plugging could have different sequences of PILD factor values.

Note that while various characteristics are described above as being used to identify plugged impulse lines, additional characteristics could also be used to facilitate the identification of plugged impulse lines. For example, in some circumstances, the temperatures in the impulse lines can be used along with PV measurements to identify any plugged impulse lines. Also note that while the use of pressure measurements are often described, any other suitable PV measurements could be used.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
collecting a set of process variable (PV) measurements generated using a sensor, the sensor fluidly coupled to one or more impulse lines;
determining a median fluctuation in the set of PV measurements;
determining a ratio using the median fluctuation and a reference median fluctuation; and
determining whether at least one of the one or more impulse lines is plugged using the ratio.

2. The method of claim 1, wherein determining whether at least one of the one or more impulse lines is plugged comprises:
determining whether the ratio is below a threshold; and
in response to determining that the ratio is below the threshold, determining that multiple impulse lines are plugged.

3. The method of claim 1, wherein determining whether at least one of the one or more impulse lines is plugged comprises:
determining whether the ratio is above a first threshold or between second and third thresholds; and
in response to determining that the ratio is above the first threshold or between the second and third thresholds, determining that a single impulse line is plugged.

4. The method of claim 1, further comprising:
normalizing the PV measurements using an upper range limit of the sensor;
wherein the median fluctuation comprises a median fluctuation of the normalized PV measurements.

5. The method of claim 1, further comprising:
determining the reference median fluctuation using PV measurements generated by the sensor during a training mode when a process is operating in a steady status.

6. The method of claim 5, further comprising:
repeating the training mode in response to determining that the process has undergone a status change.

7. The method of claim 1, further comprising:
generating an alarm in response to determining that at least one of the one or more impulse lines is plugged.

8. An apparatus comprising:
at least one memory configured to store a set of process variable (PV) measurements generated using a sensor; and
at least one processing device configured to:
determine a median fluctuation in the set of PV measurements;
determine a ratio using the median fluctuation and a reference median fluctuation; and
determine whether at least one impulse line fluidly coupled to the sensor is plugged using the ratio.

9. The apparatus of claim 8, wherein, to determine whether at least one of the one or more impulse lines is plugged, the at least one processing device is configured to:
determine whether the ratio is below a threshold; and
in response to determining that the ratio is below the threshold, determine that multiple impulse lines are plugged.

10. The apparatus of claim 8, wherein, to determine whether at least one of the one or more impulse lines is plugged, the at least one processing device is configured to:
determine whether the ratio is above a first threshold or between second and third thresholds; and
in response to determining that the ratio is above the first threshold or between the second and third thresholds, determine that a single impulse line is plugged.

11. The apparatus of claim 8, wherein:
the at least one processing device is further configured to normalize the PV measurements using an upper range limit of the sensor; and
the median fluctuation comprises a median fluctuation of the normalized PV measurements.

12. The apparatus of claim 8, wherein the at least one processing device is further configured to determine the reference median fluctuation using PV measurements generated by the sensor during a training mode when a process is operating in a steady status.

13. The apparatus of claim 12, wherein the at least one processing device is further configured to repeat the training mode in response to determining that the process has undergone a status change.

14. The apparatus of claim 8, wherein the at least one memory and the at least one processing device form part of one of:
the sensor; and
a plugged impulse line detector configured to communicate with the sensor.

15. The apparatus of claim 8, wherein the set of PV measurements comprises a set of pressure measurements.

16. A non-transitory computer readable medium containing instructions that, when executed by at least one processing device, cause the at least one processing device to:
collect a set of process variable (PV) measurements generated using a sensor;
determine a median fluctuation in the set of PV measurements;
determine a ratio using the median fluctuation and a reference median fluctuation; and
determine whether at least one impulse line fluidly coupled to the sensor is plugged using the ratio.

17. The non-transitory computer readable medium of claim 16, wherein the instructions that when executed cause the at least one processing device to determine whether at least one of the one or more impulse lines is plugged comprise:
instructions that when executed cause the at least one processing device to:
determine whether the ratio is below a threshold; and
in response to determining that the ratio is below the threshold, determine that multiple impulse lines are plugged.

18. The non-transitory computer readable medium of claim 16, wherein the instructions that when executed cause the at least one processing device to determine whether at least one of the one or more impulse lines is plugged comprise:
instructions that when executed cause the at least one processing device to:
determine whether the ratio is above a first threshold or between second and third thresholds; and
in response to determining that the ratio is above the first threshold or between the second and third thresholds, determine that a single impulse line is plugged.

19. The non-transitory computer readable medium of claim 16, further containing instructions that when executed cause the at least one processing device to normalize the PV measurements using an upper range limit of the sensor;
wherein the median fluctuation comprises a median fluctuation of the normalized PV measurements.

20. The non-transitory computer readable medium of claim 16, further containing instructions that when executed cause the at least one processing device to:
determine the reference median fluctuation using PV measurements generated by the sensor during a training mode when a process is operating in a steady status; and
repeat the training mode in response to determining that the process has undergone a status change.
